(19) United States
(12) Patent Application Publication
(10) Pub. No.: US 2026/0231241 A1
(43) Pub. Date: Aug. 6, 2026

(54) AIOT - METHODS FOR DEVICE ORIGINATED AUTONOMOUS (DO-A) TRANSMISSION IN AIOT

(71) Applicant: InterDigital Patent Holdings, Inc., Wilmington, DE (US)

(72) Inventors: Martino Freda, Laval (CA); Paul Marinier, Brossard (CA); Erdem Bala, East Meadow, NY (US); Kevin Wanuga, Souderton, PA (US); Jongwoo Hong, New York, NY (US); Patrick Tooher, Montreal (CA)

(73) Assignee: InterDigital Patent Holdings, Inc., Wilmington, DE (US)

(21) Appl. No.: 19/044,056

(22) Filed: Feb. 3, 2025

(51) Int. Cl. H04W 74/0838; H04W 72/04

(52) U.S. Cl. CPC H04W 74/0838; H04W 72/04

(57) ABSTRACT

Disclosed herein is a reader, AIOT device, and methods thereof for handling AIOT device-originated autonomous data transmission. Details include a reader transmitting a first preamble sequence of a set of preamble sequences. The reader receives at least one preamble sequence of the set of preamble sequences. The reader then determines whether a single preamble sequence or multiple preamble sequences are received. Based the received preamble(s), the reader sends a message indicating that one or more AIOT devices are to perform contention-based or contention-free random access.

### BACKGROUND

In recent years, IOT has attracted much attention in the wireless communication world. More ‘things’ are expected to be interconnected for improving productivity efficiency and increasing comforts of life. Further reduction of size, complexity, and power consumption of IOT devices can enable the deployment of tens or even hundreds of billions of IoT devices for various applications and provide added value across the entire value chain. It is a challenge to power all the IOT devices by a battery that needs to be replaced or recharged manually, which leads to high maintenance cost, serious environmental issues, and even safety hazards for some use cases, for example a wireless sensor in electric power and petroleum industry.

Considering the limited size and complexity required by practical applications for batteryless devices with no energy storage capability or devices with limited energy storage that do not need to be replaced or recharged manually, the output power of an energy harvester is typically from 1 μW to a few hundreds of μW. Existing cellular devices may not work well with energy harvesting due to their peak power consumption of higher than 10 mW.

Currently, attention is focused on Device Terminated (DT) and Device Originated-Device Terminated Triggered (DO-DTT) use cases. In DT use cases, a reader triggered by an AIOT application in the network initiates a targeted write procedure to write data to one or more AIOT devices. For example, in the use case for online modification of medical instruments, an AIOT application can modify the status in an AIOT device corresponding to a medical instrument by writing the status to the device. In DO-DTT use cases, a reader triggered by an AIOT application in the network can trigger a read operation or an inventory of all devices in an area, possibly corresponding to a subgroup of device IDs. Such operation may be performed in normal planned inventory applications.

One scenario for consideration is how to perform DO-A. This scenario may be used for sensor applications, where a sensor may indicate a status or provide information to the AIOT application when a condition in the field is met, for example when a certain temperature is met, a level of gas exceeds a threshold, etc.

### SUMMARY

In the use cases supported by Rel19, a device will be able to be inventoried by a reader by responding to a paging message using an AIOT-specific random access procedure. The inventory procedure is triggered by a network application when it wants to read and/or write information from a set of AIOT devices in the vicinity. The number of devices may be unknown, however, there is an expectation by the application function that there will be a number of responses sent to the reader.

In DO-A, a device may autonomously generate data to be sent to the network. To support the DO-A use case, there needs to be a mechanism for the device to initiate transmission autonomously, for example, at a time which is not necessarily known or predicated by the reader or the network.

In normal Uu, a UE is able to perform autonomous transmissions, for example, following a period of inactivity, using a RACH procedure. The RACH procedure may be enabled by the presence of RACH resources allocated by the network of which the UE is aware via system information. Such an approach for autonomous transmissions for an AIOT device is not feasible.

Periodically monitoring a message which contains the timing information of transmission resources, for example resources similar to RACH resources, or acquiring and storing such information would consume significant energy at the device, which is not ideal for such low energy/cost devices.

Due to a lack of adequate synchronization and clock drift, an AIOT device may not be able to maintain an accurate enough timing to perform transmission on such RACH resources without reader intervention

Periodic transmission of the paging message could be another approach for supporting DO-A. This approach, however, may be resource inefficient and device power inefficient because at times there will be no response to the paging message. Each transmission of the paging message requires one or more resources to be allocated for the contents of the paging message, for example a value of Q that may be an index that determines the number of random access occasions in RFID, ID, etc., as well as the allocation of one or more resources for a potential device response which may or may not occur. Since the paging message may be of fixed size, e.g., for device complexity reasons, it may be relatively large to support a large number of use cases and/or to encompass one or multiple device IDs. Decoding such a paging message at a device without DO-A traffic only to learn that the paging message is intended for a device with DO-A traffic will result in unnecessary power consumption for all devices, including those which are not enabled for DO-A.

Disclosed herein are access mechanisms for DO-A in AIOT that limit power consumption at the devices and are compatible with DO-DTT and DT design.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a message sequence chart illustrating example communications between an RFID interrogator and an RFID tag;

FIG. 3 is a system diagram illustrating an example AIOT topology;

FIG. 4 is a system diagram illustrating another example AIOT topology;

FIG. 5 is a system diagram illustrating another example AIOT topology;

FIG. 6 is a system diagram illustrating another example AIOT topology;

FIG. 7 is a system diagram illustrating another example AIOT topology;

FIG. 8 is a message sequence chart illustrating an embodiment of an example communications between a reader and an AIOT device;

FIG. 9 is a system diagram illustrating an example AIOT device;

FIG. 10 is an illustration of an example procedure for an AIOT device transmitting a DO-A transmission;

FIG. 11 is a signaling diagram of an example procedure involving an AIOT device having data for a DO-A transmission, a reader, and a network; and

FIG. 12 is a flow diagram of an example method performed by a WTRU acting as a reader.

### DETAILED DESCRIPTION

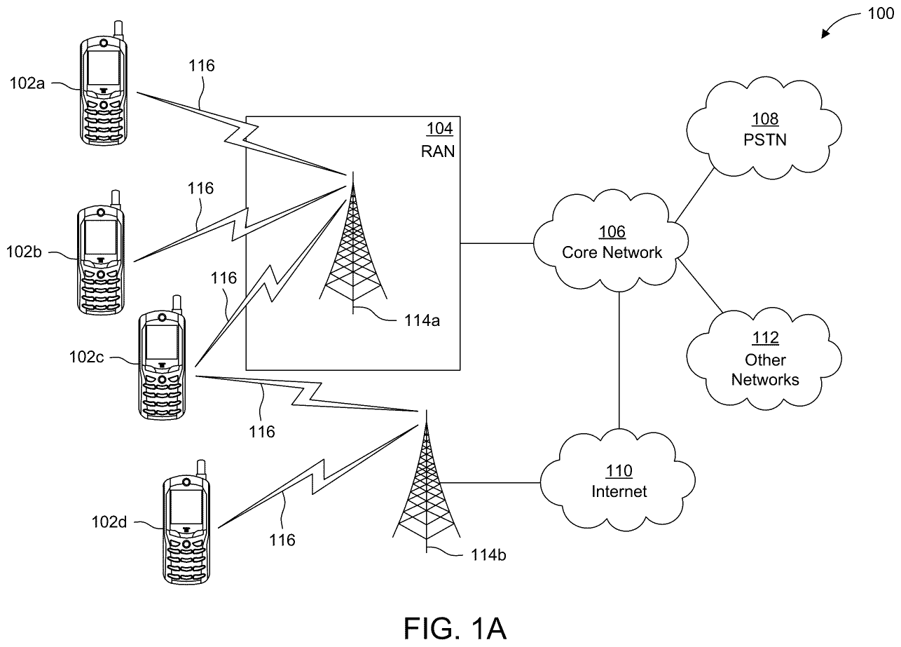

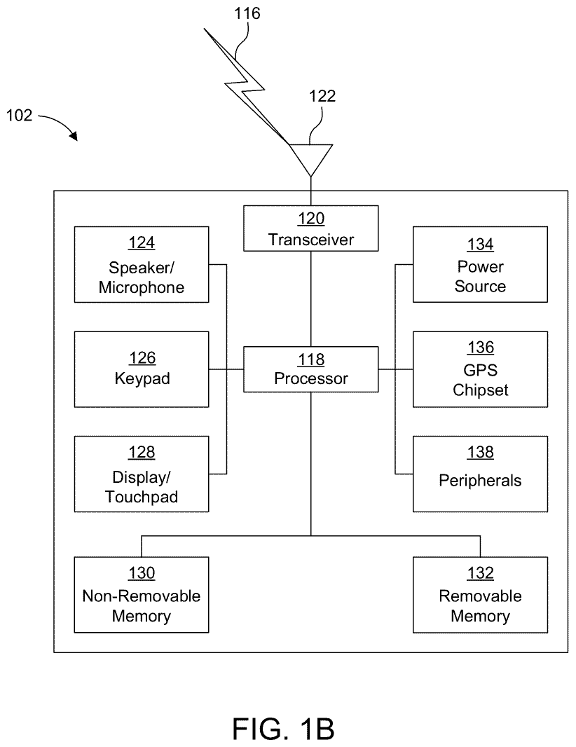

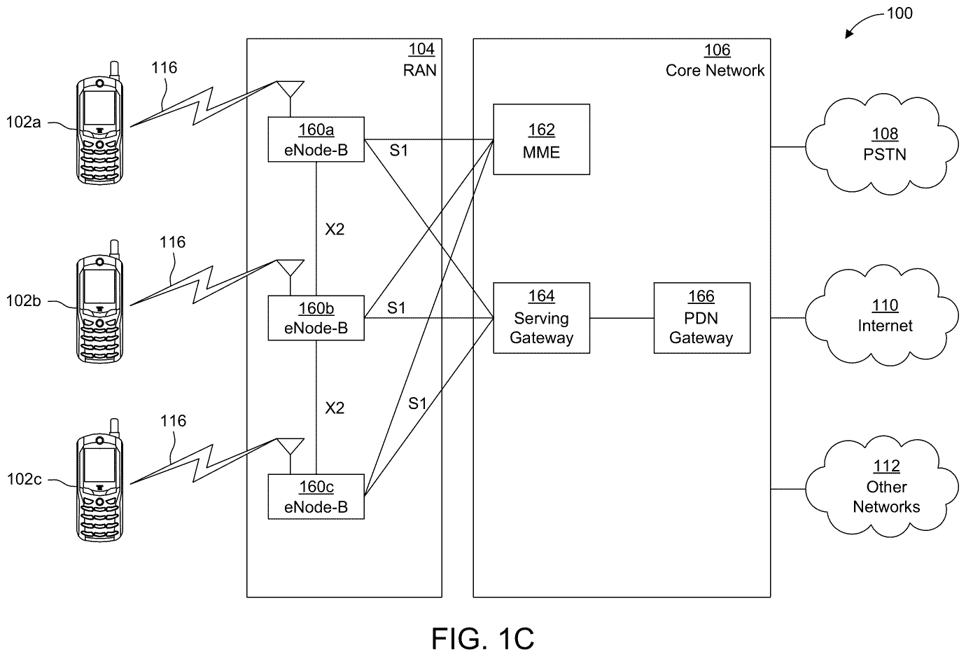

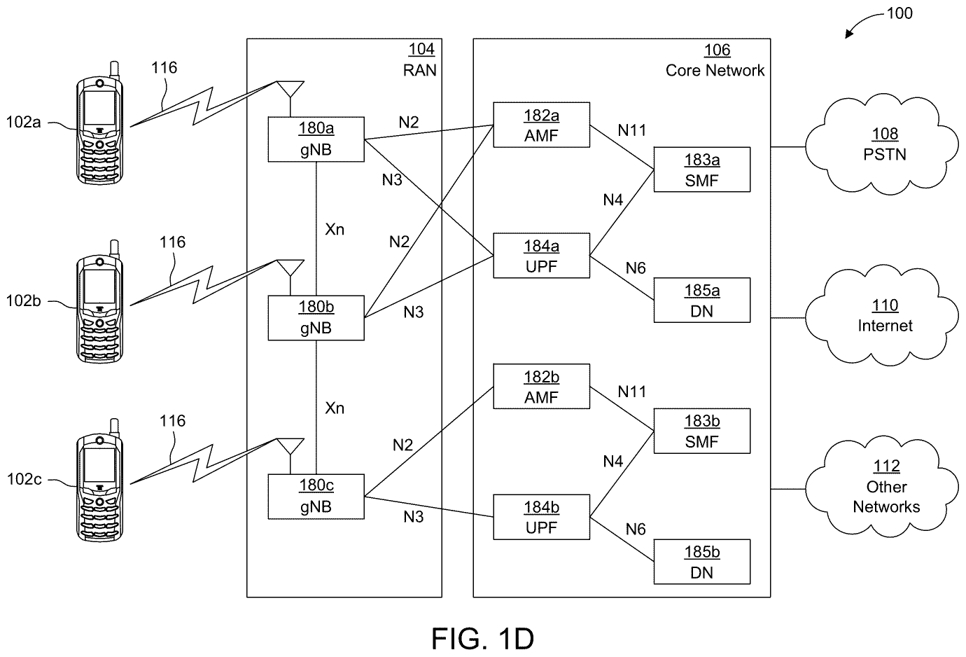

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### ABBREVIATIONS AND ACRONYMS

AIOT Ambient Internet Of Things
ALOHA Additive Links On-line Hawaii Area
CE Control Element
D2R Device to Reader
DC Dual connectivity
DCI Downlink Control Information
DL Downlink
DO-DTT Device Originated - Device Terminated Triggered
DO-A Device Originated Autonomous
DT Device Terminated
IOT Internet Of Things
LTE Long Term Evolution e.g. from 3GPP LTE R8 and up
MAC Medium access control
MIMO Multiple Input Multiple Output
NR New Radio
OFDM Orthogonal Frequency-Division Multiplexing
PHY Physical Layer
R2D Reader to Device
RA Random Access (or Random Access procedure)
RACH Random Access Channel
RF Radio Front end or Radio Frequency
RFID Radio Frequency Identification
RRC Radio Resource Control
SR Service Request

### UL Uplink

URLLC Ultra-Reliable and Low Latency Communications

WLAN Wireless Local Area Networks and related technologies (IEEE 802.xx domain)

In this disclosure, the terms device, AIOT UE, and tag may be used interchangeably to mean an AIOT device that is being inventoried/queried by a reader.

The term reader may refer to the entity which queries the AIOT device, either directly, or via an intermediate UE (see FIG. 4). For example, in FIG. 4, the intermediate node 406 may or may not be a UE, which may also be referred to as the reader. As a result, the term reader may refer to a network node or a UE, depending on the context and/or the topology.

In this disclosure, the terms reader, network, and intermediate UE may be used interchangeably.

In this disclosure, inventory may refer to the overall procedure of a reader triggering access by multiple devices using a sequence of messages. The sequence of message may, for example, be similar to query, followed by query rep in RFID. The inventory procedure may refer to a round of attempts to have each device respond or attempt to respond with its access ID or perform a RACH procedure. The inventory procedure may also refer to a set of access occasions which may have 0 or at least 1 device respond within an access occasion.

An inventory procedure may occur similar to legacy RFID procedure. Although referred to herein as inventory procedure, different terms may be used in device requirements or specifications, for example, a query procedure, a paging procedure, etc.

In this disclosure, an occasion may refer to an opportunity for device transmission. The opportunity may be delimited by a transmission of a query rep message from, for example, a reader. For example, a device may perform transmission in an occasion by performing an AIOT transmission in a defined time following the query rep associated with that AIOT transmission. Alternatively, an occasion may include both a time aspect and a frequency aspect. For example, a device may determine an occasion as a transmission at a time following a specific query rep, and on one or more of a number of frequencies (e.g., FDM, OFDM, or any other frequency divided multiplexing technique). Wherever solutions indicate selection of an occasion, they can apply equivalently to selection of only a time component and/or selection of a frequency component. Further, embodiments disclosed herein may cover occasions more broadly to include a wired or wireless resource that may be used in a multiplexed fashion with other wireless resources. For example, CDM or spatial multiplexing may additionally or alternatively be employed.

Herein, depending on the solution or description, a reference to time can be associated with an absolute time measurement, for example seconds, slots, frames, etc. Additionally or alternatively, a reference to time can refer to a number of executions of a procedure, possibly triggered by a reader, for example a number of inventory procedures, a number of accesses or RACH procedures, etc. Additionally or alternatively, a reference to time can refer to a number of messages, possibly of a specific type, or containing specific information, as described herein, received or transmitted.

Herein, DO-A traffic or DO-A data may include data transmitted by an AIOT device to an AIOT reader as a result of an AIOT device autonomously generating the data and indicating the need to send such data. Such data may be generated asynchronously or in a pattern or timing that is not predictable, for example, by the AIOT reader. However, solutions herein which refer to DO-A traffic may not be limited to such type of traffic alone and may apply to any data transmitted from a device to a reader.

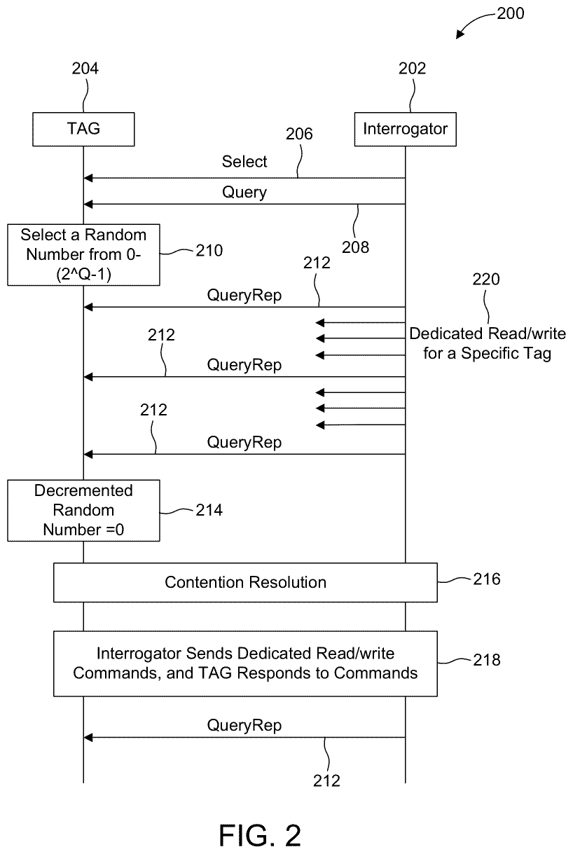

FIG. 2 is a message sequence chart illustrating an embodiment of an example communications 200 between an interrogator 202 and a tag 204, which may also be known as an RFID interrogator 202 and RFID tag 2024, respectively. The message sequence may be an example sequence used for applications of asset identification and may be referred to as an inventory procedure. It should be noted that although the figure depicts a series of particular messages, messages may be deleted from the series, a different order of messages may be implemented, and additional messages not depicted may be inserted in the message sequence without departing from the embodiment.

The interrogator 202 may send messages to the tag 204. The messages may include one or more of a Select message 206, a Query message 208, a QueryRep message 212, a message in connection with a contention resolution procedure 216, a message in connection with dedicated read or write command procedure 218. The interrogator 202 may further, at any time during the example communication 200, send one or more dedicated read or write commands 220 for a specific tag that is different than tag 204. Tag 204 may send messages to the interrogator 202. The messages may include one or more messages in connection with contention resolution 216 and/or one or more messages associated with the dedicated read or write command procedure 218, where the one or more messages may be in response to one or more of the dedicated read or write commands. Any single depicted message in FIG. 2 may be embodied by multiple message or multiple messages depicted in FIG. 2 may be embodied by a single message.

For example, the interrogator 202 may send a Query 208 to energize all or a subset of RFID tags 204. Following a Query 208, a tag 204 may select a random number from 0-2^{Q-1} and loads its memory, and/or a counter, with that number at 210. At each transmission of a QueryRep 212, the tag 204 may decrement its counter, which may be embodied in memory, until the counter reaches 0 at 214. When the counter reaches 0, the tag 204 may initiate a contention resolution procedure 216 which may include the tag 204 transmitting its device ID, for example in the uplink, and waiting for confirmation of the device ID, for example in the downlink. This contention resolution procedure 216 may be used to address possible collision between multiple devices selecting the same random number. For a device, such as tag 204, that has passed contention resolution procedure 216, the interrogator 216 can send one or more read or write commands to which the tag 204 should respond in the read or write command procedure 218.

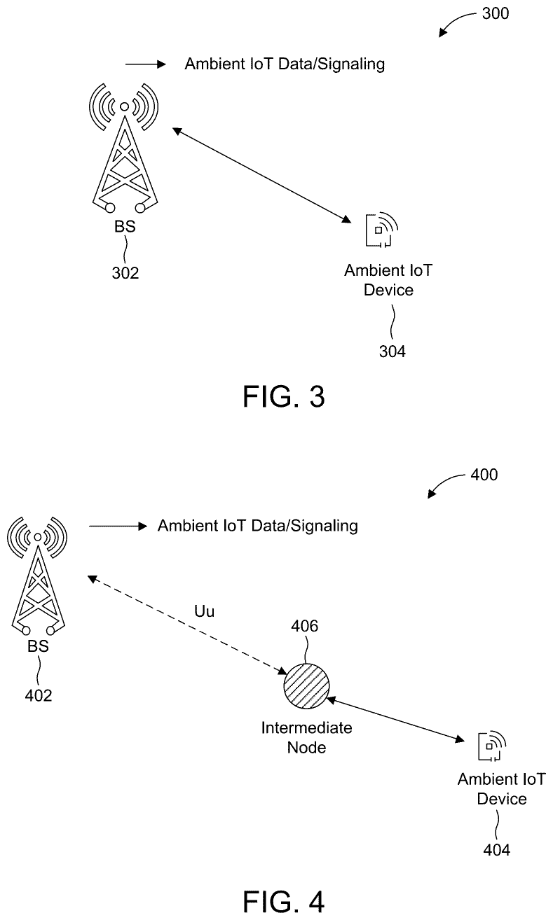

FIG. 3 is a system diagram illustrating an example AIOT topology 300, which has a structure referred to as Topology 1. Topology 300 includes a base station (BS) 302 in communication with an AIOT device 304. The structure of topology 300 can be represented with text as: BS↔AIOT device. In topology 300, AIOT device 304 directly and bidirectionally communicates with BS 302. In some implementations, the communication between the BS 302 and AIOT device 304 includes AIOT data and/or other AIOT signaling. In some implementations (not shown) different BS devices may transmit to and receive from AIOT device 304 in topology 1. In this case, topology 1 may be represented with text as: BS1->AIOT device->BS2.

FIG. 4 is a system diagram illustrating an example AIOT topology 400, which has a structure referred to as Topology 2. Topology 400 includes a base station (BS) 302 in communication with an AIOT device 304 via an intermediate node 406. The structure of topology 400 can be represented with text as: B↔intermediate node↔AIOT device. In topology 400, AIOT device 404 directly and bidirectionally with intermediate node 406, and intermediate node 406 communicates directly and bidirectionally with BS 402. In some implementations, the communication between the BS 402 and AIOT device 404 (via intermediate node 406) includes AIOT data and/or other AIOT signaling. In some implementations, an intermediate node may be or include a relay, IAB node, WTRU, repeater, etc., which is capable of Ambient IoT communications. In some implementations, intermediate node 406 transfers information between BS 402 and the AIOT device 404.

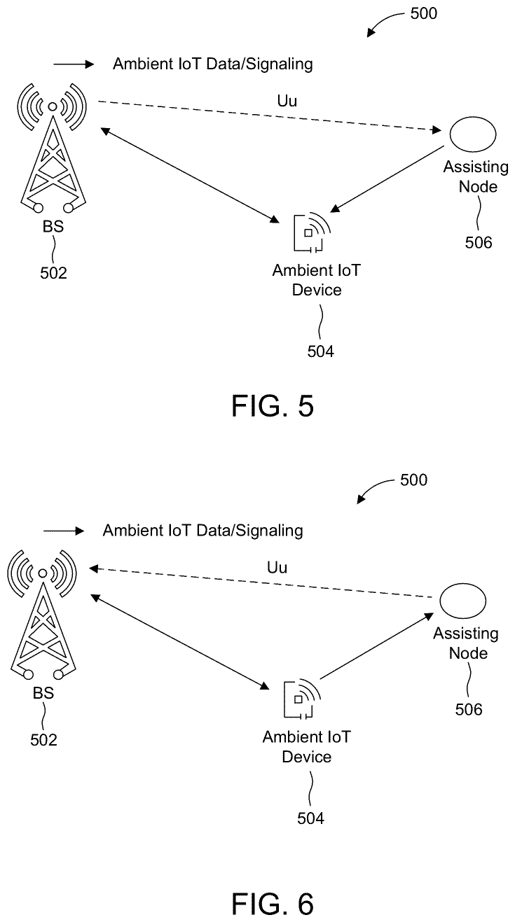

FIGS. 5 and 6 are a system diagrams illustrating an example AIOT topology 500, which has a structure referred to as Topology 3. Topology 500 includes a base station (BS) 302 in communication with an AIOT device 304, assisted by an assisting node 506. In some implementations, an assisting node may be or include a relay, IAB node, WTRU, repeater, etc., which is capable of Ambient IoT communications. The structure of topology 500 can be represented with text as: BS↔assisting node↔AIOT device↔BS.

In FIG. 5, AIOT 504 is operating in topology 500 with downlink assistance. Here, AIOT device 504 transmits AIOT data and/or AIOT signaling to BS 502, and receives AIOT data and/or AIOT signaling from assisting node 506 (which has received the AIOT data and/or AIOT signaling from BS 502, e.g., over a Uu link).

In FIG. 6, AIOT 504 is operating in topology 500 with uplink assistance. Here, AIOT device 504 receives AIOT data and/or AIOT signaling from BS 502, and transmits AIOT data and/or AIOT signaling to assisting node 506 (which transmits the AIOT data and/or AIOT signaling to BS 502, e.g., over a Uu link).

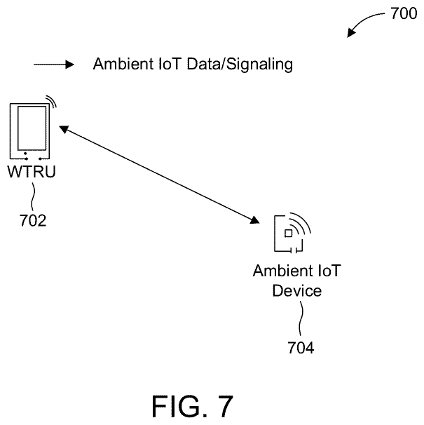

FIG. 7 is a system diagram illustrating an example AIOT topology 700, which has a structure referred to as Topology 4. Topology 700 includes a WTRU 702 (e.g., a UE) in communication with an AIOT device 704. The structure of topology 700 can be represented with text as: WTRU↔AIOT device. In topology 700, AIOT device 704 directly and bidirectionally communicates with WTRU 702. In some implementations, the communication between WTRU 702 and AIOT device 704 includes AIOT data and/or other AIOT signaling. In some implementations (not shown) different WTRU devices may transmit to and receive from AIOT device 304 in topology 4. In this case, topology 4 may be represented with text as: WTRU->AIOT device->WTRU.

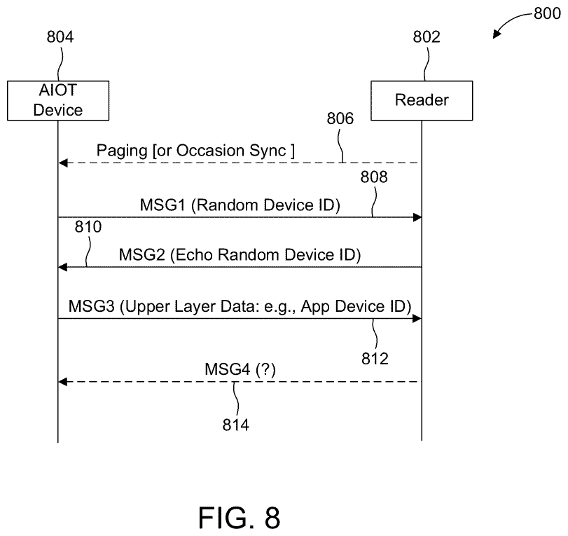

FIG. 8 is a message sequence chart illustrating an embodiment of an example communications 800 between a reader 802 and an AIOT device 804. Example communications 800 depicts an example AIOT access framework. In accordance with the above description, an example of the reader 802 may be a WTRU and an example of the AIOT device 804 may be a tag. At 806, the reader 802 may send a paging message and a set of occasion synchronization messages. Each of the occasion synchronization messages respectively provides a device ID for a responding AIOT device corresponding to the ID, such as AIOT device 804, and configures and/or delimits the random access occasions for transmissions by the AIOT device 804 corresponding to the ID. At 808, AIOT device 804 selects a random access occasion, for example using slotted ALOHA as a baseline, and transmits a random device ID in MSG1. In slotted ALOHA, a time may be divided into discrete slots, and a device starts transmitting data at the beginning of a slot, which may reduce a chance of collision with a transmission from another device. At 810, reader 802, upon successful reception of MSG1, may transmit MSG2 to AIOT device 804. MSG2 may include the received random device ID. At 812, if AIOT device 804 receives the echoed random device ID in MSG2, it transmits MSG3 to the reader 802. MSG3 may include upper layer data, for example an application layer device ID. At 814, the reader 802 may transmit MSG4. Transmitting MSG4 may be for subsequent command transmission. It should be understood, however, that contention was resolved at 810 when the reader 802 transmits MSG2 including the random device ID back to the AIOT device 804.

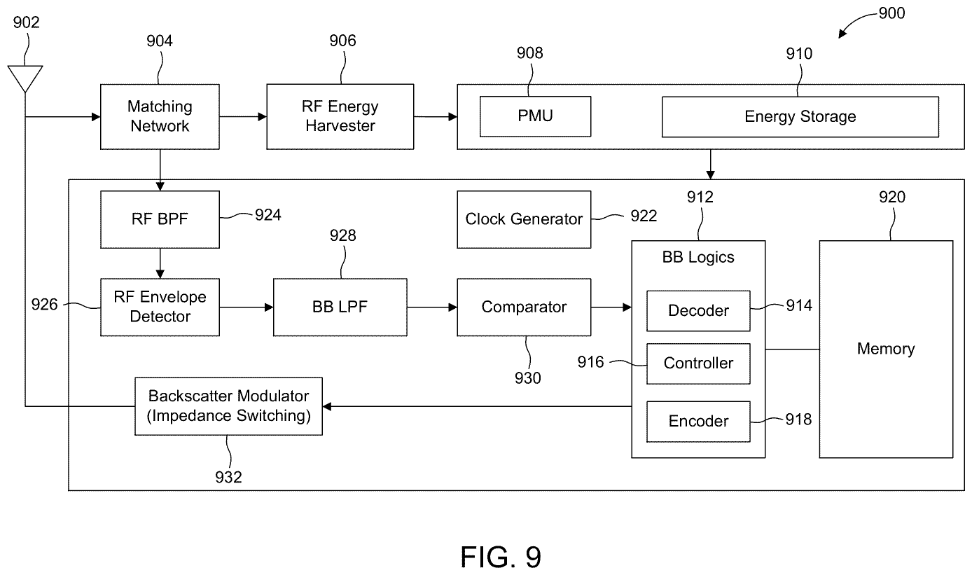

FIG. 9 is a system diagram illustrating an example AIOT device 900. The AIOT device 900 depicted in FIG. 9 is meant to be exemplary only. An AIOT device as described herein may include additional circuitry or may not include all of the depicted circuitry without departing from the scope of the disclosure. The AIOT device 900 may include one or more antennas 902 that could be either shared or separate for RF energy harvesting and receiving/transmitting data. The AIOT device 900 may further include a matching network 904 that may be configured to match impedance between antenna 902 and other components that may include RF energy harvester 906 and receiver related circuitry such as RF bandpass filter 9xx, RF envelope detector 9xx, baseband lowpass filter 9xx, and comparator 9xx. The AIOT device 900 may further include an RF energy harvester 906 that may include a rectifier that performs RF signal AC to DC conversion. The AIOT device 900 may further include energy storage 910, e.g., a capacitor, that may store harvested energy from RF energy harvester 906. The AIOT device 900 may further include power management unit (PMU) 908 that may manage storing energy to energy storage from energy harvester 906 and supply power to active component blocks that may need power. The AIOT device 900 may further include digital baseband logic 912 that may include circuitry such as an encoder 918, a decoder 914, and/or controller 916, etc. The AIOT device 900 may further include memory 920. For example, memory 920 may include one or more types of memory. For example, non-volatile memory (NVM) such as EEPROM may, for example, permanently store a device ID, etc. In another example of memory 920, registers may temporarily keep any information required for AIOT device 900 operation while energy is available in energy storage 910. The AIOT device 900 may further include a clock generator 922 that may be configured to provide one or more clock signals. The AIOT device 900 may further include an RF bandpass filter 924 may be configured to improve reception selectivity. The AIOT device 900 may further include an RF envelope detector 926 that may be configured to convert an RF signal to baseband. The AIOT device 900 may further include a baseband lowpass filter 928 that may be configured to filter out harmonics and/or high frequency components to improve input signal quality to comparator 930. The AIOT device 900 may further include a comparator 930 that may be configured to determine a high or low output value based on input signal and a threshold value for comparison. The AIOT device 900 may further include transmission related circuitry such as a backscatter modulator 932. The backscatter modulator 932 may be configured to switch impedance to modulate a backscattered signal with a transmitted signal from baseband logic 912.

Embodiments described herein include transmitting, for example by a reader, a probe signal to initiate DO-A data transmission by one or more AIOT devices. As described herein, the reader may be but is not limited to, e.g., a WTRU or gNB. For example, a reader may transmit a probe signal to trigger a response from any or all devices which may have data pending for transmission. Herein, the term probe signal is used commonly for the transmission by the reader to initiate the DO-A data transmission by one or more AIOT devices. The term probe signal response refers to the response by the one or more AIOT devices which may include a response, the response and the actual data, or the actual data. The probe signal and probe signal responses may be a preamble, an AIOT message, a combination of the two, etc., as described in more detail herein.

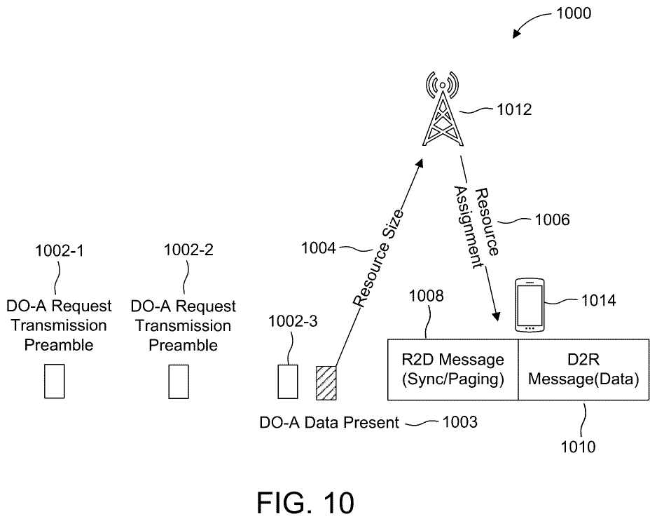

FIG. 10 is an illustration of an example procedure 1000 for an AIOT device transmitting a DO-A transmission. A reader 1014, such as a WTRU, may be configured to transmit a periodic probe signal 1002-1, 1002-2, 1002-3 in the form of a preamble only transmission (“DO-A Request Transmission Preamble”). Although three preamble transmissions are depicted, any number of transmissions is within the scope of this disclosure. When an AIOT device enabled for DO-A has data available for transmission, it may transmit a probe response signal 1003 (“DO-A data present”) following the probe signal after which the data is available. The reader 1014 may then transmit a request 1004 to network 1012 to request resources including an indication of a resource size to accommodate at least the AIOT device's D2R message (data) 1010 and the R2D message (sync/paging) 1008. The network 1012 may then transmit an indication of a resource assignment or allocation 1006 to the reader 1014. The reader 1014 may transmit the R2D message 1008, which may be, for example, a sync message or paging message, to the AIOT device. The AIOT device may then transmit the D2R message 1010, which may be, e.g., a data transmission such as a MSG3 transmission.

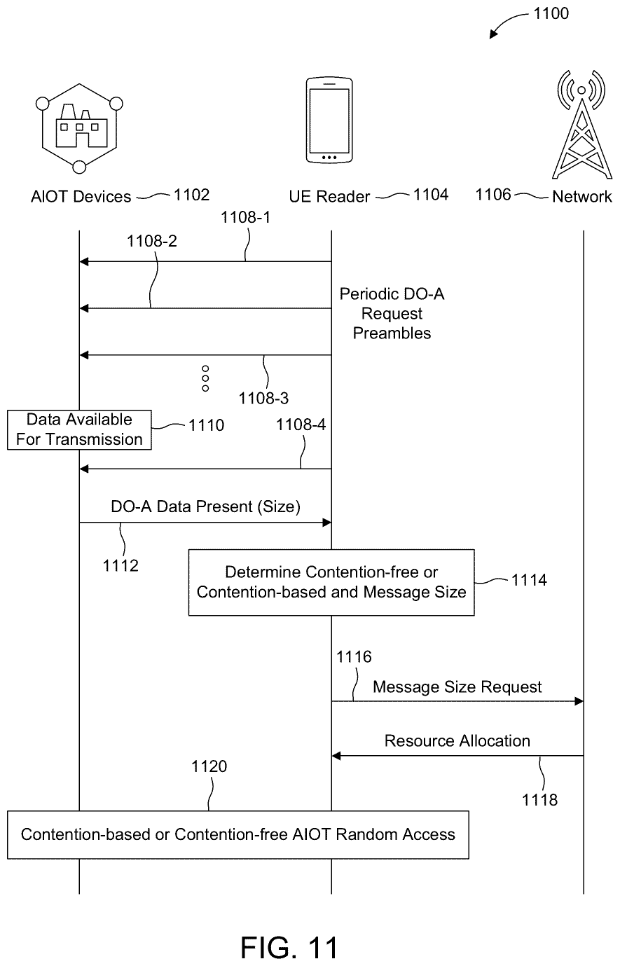

FIG. 11 is a signaling diagram of an example procedure involving an AIOT device 1102 having data for a DO-A transmission, a reader 1104, such as a UE reader, and a network 1106, such as a base station or gNB. Although only one AIOT device 1102, one reader 1104, and one network 1106 are depicted, multiple AIOT devices 1102, multiple readers 1104, and multiple networks 1106 may be present. The reader 1104, such as a WTRU, may be configured to transmit a periodic probe signal 1108-1, 1108-2, 11083, and 1108-4 in the form of a preamble only transmission (“DO-A Request Transmission Preambles”). Although four preamble transmissions are depicted, any number of transmissions is within the scope of this disclosure. When the AIOT device 1102 enabled for DO-A has data available for transmission 1110, it may transmit a probe response signal 1112 (“DO-A data present”) following the probe signal after which the data is available. The probe response signal 1112 may, for example, indicate, in accordance with any of the ways described herein, that data is present and may indicate a size of the data. The reader 1104 may then determine 1114 whether to use a contention-free or contention-based procedure and may determine a size of resources needed according to the determined procedure and amount of data indicated by the AIOT device 1102 by the probe response signal 1112. For example, the reader 1104 may send the DO-A data message size information or information about the type of random access procedure at 1116 to allow the network 1106 to allocate the correct amount of resources. Additionally or alternatively, as described in greater detailed elsewhere herein, the reader 1014 may, for example, determine to use a contention-free procedure if only one probe response signal, which may be, e.g., a preamble, is successfully received. In another example, the reader 1104 may determine to use a contention-based procedure if multiple probe response signals, again which may be preambles in some examples, are received. Alternatively, contention-based vs. contention-free random access may be indicated, for example in a resource allocation message 1118, to the reader 1104 from the network 1106 following the request 1116. Following resource allocation by the network 1106 (“Resource Assignment” or “Resource Allocation”) 1118, the reader 1104 may use one or more resources from the resource allocation to send the AIOT messages that trigger the subsequent procedure 1120. For example, the reader 1104 may send one or more R2D messages, such as sync or paging messages, to trigger the subsequent procedure 1120. The reader 1104 may also inform the one or more AIOT devices 1102 about the resources for the subsequent D2R messages (e.g., the data, such as in MSG3 transmissions). Although not depicted, the one or more AIOT devices 1102 may then transmit data to the reader 1104 using the resources indicated by the reader 1104.

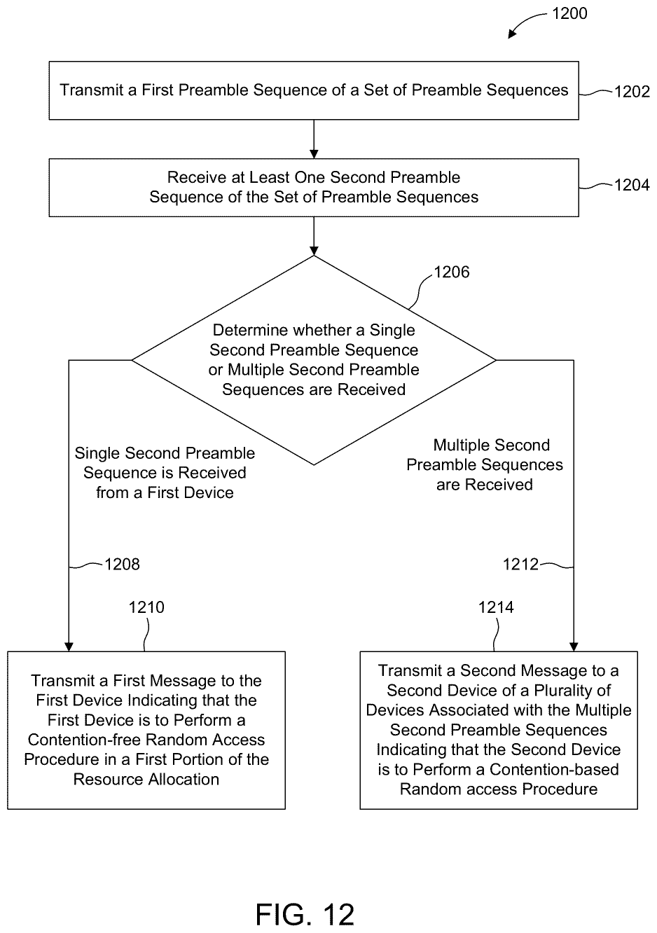

FIG. 12 is a flow diagram of an example method 1200 performed by a WTRU acting as a reader. A WTRU may be an example of a reader capable of performing method 1200, wherein the WTRU may include circuitry that includes a transmitter, a receiver, a processor, and a memory, and/or may be embodied by any portion of the circuitry depicted in FIG. 1B configured to perform the steps of the method 1200. At 1202, a reader may transmit a first preamble sequence at 1202. The first preamble sequence may be of a set of preamble sequences. At 1204, the reader may receive at least one second preamble sequence. The second preamble sequence may be of the set of preamble sequences. At 1206, the reader may determine whether a single second preamble sequence or multiple second preamble sequences are received.

On a condition 1208 that a single second preamble sequence is received from a first device, at 1210 the reader may transmit a first message to the first device indicating that the first device is to perform a contention-free random access procedure in a first portion of the resource allocation. On this condition, for example, the single second preamble sequence may have been received in a period of time following the transmission of the first preamble sequence. In some examples, the reader may also request from a network a resource allocation based on a size associated with the single second preamble sequence. In some examples, requesting the network may include sending an indication of the size of the requested resource allocation. In some examples, the reader may receive, from the network, an indication of the resource allocation. In some examples, the reader may transmit the first message, to the first device, in a first portion of the resource allocation. In some examples, the first message may indicate that the first device is to transmit data contention-free and indicates at least the second portion of the resource allocation. In some examples, the reader may receive a contention-free data transmission from the first device in a second portion of the resource allocation. In some examples, a value of the single second preamble sequence may be based on a size of the subsequent contention-free data transmission.

On a condition 1212 that multiple second preamble sequences are received, at 1214 the reader may transmit a second message to a second device of a plurality of devices associated with the multiple second preamble sequences indicating that the second device is to perform a contention-based random access procedure. In some examples, the second message may be transmitted in one or more first resources of the resource allocation. On the condition that multiple second preamble sequences are received, for example, the multiple second preamble sequences may have been received in a period of time following the transmission of the first preamble sequence. In some examples, the reader may request from a network a resource allocation including one or more contention-based resources, wherein a size of the resource allocation may be based on a maximum of one or more sizes associated with the multiple second preamble sequences. In some examples, the reader may receive, from the network, the resource allocation that includes the one or more contention-based resources. In some examples, the reader may receive, in at least one contention-based resource of the one or more contention-based resources from the second device, an MSG1 transmission containing a random number. In some examples, in response, the reader may transmit, in one or more second resources of the resource allocation to the second device, a MSG2 transmission containing the random number. In some examples, the reader may receive, in one or more third resources of the resource allocation from the second device, a data transmission. In some examples, a value of each second preamble sequence of the multiple second preamble sequences may be based on a size of a respective subsequent data transmission.

In an example embodiment, a reader may transmit a probe signal based on one or a combination of: periodicity or time between probe signal transmissions, resource availability, a network configuration and/or indication, availability of Uu resources, an indication from one or more devices based on a previous interaction with the reader, and properties of a transmission by one or more devices from a previous interaction with the reader. For example, a previous interaction with the reader may include an inventory procedure or previous DO-A transmission by the one or more devices.

As described above, the reader may transmit a probe signal based on, inter alia, the periodicity or time between probe signal transmissions. For example, a reader may initiate a timer upon a probe signal transmission or upon completion of a transmission by one or more devices. Upon expiry of a timer, the reader may transmit another probe signal.

As described above, the reader may transmit a probe signal based on, inter alia, resource availability. For example, a reader may receive from the network a set of resources to use for probe signal transmission and for corresponding device responses. The reader may perform the probe signal transmissions in one of the resources, possibly combined with another condition herein, for example periodicity as described above. For example, a reader may determine whether to transmit a probe signal on a given occasion or in a specific allocated resource based on whether such resources are sufficient for transmission of the probe signal and sufficient for the corresponding response. If the resources not sufficient, a reader may skip transmission of the probe signal and/or inform the network to request additional resources.

As described above, the reader may transmit a probe signal based on, inter alia, a network configuration and/or indication. For example, a reader may receive an indication or configuration indicating a periodicity for probe signal transmission from the network, for example, in RRC messaging, in NAS signaling, etc., and may use the indicated/configured periodicity to determine the actual probe signal transmission times. In another example, a reader may receive an explicit indication of one or more allocated resources, for example in an RRC message, for transmitting a probe signal and may perform such transmission in one or more of the allocated resources.

As described above, the reader may transmit a probe signal based on, inter alia, Uu resources, that is resources for signaling between, e.g., a gNB and the WTRU. For example, a WTRU may receive Uu resources and may decide whether to use the resources for Uu transmissions, or for probe signal transmissions. For example, a probe signal may be transmitted in a resource allocated to the WTRU for which the WTRU does not have any Uu transmissions to perform. For example, a WTRU may be configured with conditions on when to prioritize probe signal transmission versus Uu transmissions, possibly based on another of the factors above.

As described above, the reader may transmit a probe signal based on, inter alia, an indication from one or more devices based on a previous interaction with the reader, and/or properties of a transmission by one or more devices from a previous interaction with the reader. Examples of a previous interaction may be an inventory procedure of AIOT devices by the reader or a previous DO-A transmission by an AIOT device. For example, a reader may set or change the periodicity of the probe signal transmission based on the response rate of previous DO-A transmissions

For example, the reader may increase or reduce the periodicity of probe signal transmissions, e.g., by a configured or preconfigured amount, upon the absence or presence of a response from one or more devices following transmission of one or more previous probe signal transmissions. In another example, a reader may set or change the periodicity of the probe signal transmission based on an explicit indication by one or more devices in an inventory procedure.

In another example, a reader may determine a periodicity based on information received from one or more devices in a past inventory procedure. For example, a reader may receive an expected or desired periodicity from one or more devices, e.g., in a control message, in a preamble, in an AIOT data element, etc., in the inventory and/or command procedure. The reader may set the probe periodicity based on the expected or desired periodicity. For example, the reader may use a minimum periodicity, an average periodicity, etc.

In another example, a reader may set or change the periodicity of the probe signal transmission based on an explicit indication by one or more devices in a previous DO-A procedure. For example, in a previous DO-A procedure, a reader may receive an explicit indication in a data transmission, a probe signal response, a subsequent random access procedure, etc.

In another example, a reader may decrease the periodicity of a probe signal following reception of a request to do so by a device during the device's random access.

In another example, a reader may determine whether to transmit a subsequent probing signal, for example at the next resource time, period, etc., or not based on an indication whether a specific device has additional DO-A data to transmit. For example, a reader may determine whether to transmit a subsequent probing signal or not based on whether a device has transmitted all of its pending data or not.

In embodiments disclosed herein, a reader may request resources for a probe signal transmission. Elements of different embodiments of resource requests for a probe signal transmission may be combined with each other and different elements of different embodiments of resource requests for probe signal transmission may be combined with other compatible embodiments described herein without departing from the scope of the disclosure.

In an embodiment, a reader may perform a request for probe signal transmission, and potential response from a device. Again, as described herein, a reader may be, but is not limited to, a WTRU. A reader may trigger such a request following the initiation of a DO-A service. Initiation may come from upper layers, from the core network, etc. Alternatively, a reader may trigger such a request following determination of the presence of at least one device which may generate DO-A traffic. For example, a reader may receive information from one or more devices during a previous inventory procedure triggered by the network, where such information may indicate that at least one of the inventoried devices is a DO-A device. For example, a reader may be triggered to enable or disable DO-A behavior at a device. In an example, DO-A behavior may be enabled or disabled through a write command to the device. In another example, if a reader enables DO-A behavior with at least one device, the reader may request resources for the probe signal transmission.

In an embodiment, a reader may include information to the network during a request for probe signal transmission. Such information may be provided explicitly, e.g., in an RRC message, or implicitly, e.g., based on the type of message or specific Uu resource used to request the probe signal resources. For example, a reader may indicate that it is requesting resources for probe signal transmission. For example, a reader may indicate the desired periodicity for the probe signal transmission. For example, a reader may indicate the requested size of the individual resources based on the expected transmission duration or resource use of the probe signal transmission and the duration or resource use of the probe signal response. For example, a reader may indicate the specific frequency resources, frequency range, etc. desired for probe signal transmission and/or response. A reader may additionally or alternatively indicate the desired transmit power with which to perform probe signal transmission.

In an embodiment, the reader may determine any of the information provided to the network when requesting resources for the probe signal. The reader may determine any of the information from, e.g., any of the received service request, upper layers in the UE, or the one or more devices themselves. In an example, a reader may obtain information about device types, device capabilities, or device service type, e.g., sensor service, etc., which may indicate the level of QoS or allowable latency of the DO-A traffic. In an example, a device may provide its DO-A traffic QoS requirements, e.g., latency requirements of data associated with DO-A traffic, during the inventory procedure, following the inventory procedure, in a command response following the inventory procedure, in a previous DO-A transmission, etc. Based on such information, the reader may request resources for the probe signal associated with an appropriate periodicity.

A reader, such as a WTRU, may send a request for probe signal resources using a DCI, SR, MAC CE, or RRC message. For example, a dedicated SR may be configured for the UE, and the UE may trigger SR to request probe signal resources. Alternatively, a UE may transmit a MAC CE or an RRC message requesting probe signal resources, and indicate the required or requested periodicity of the probe signal as one of the elements in the MAC CE or RRC message.

In embodiments disclosed herein, a reader may determine one or more properties of a probe signal transmission. Elements of different embodiments covering the determination of one or more properties of the probe signal transmission may be combined with each other and different elements of different embodiments covering the determination of one or more properties of the probe signal transmission may be combined with other compatible embodiments described herein without departing from the scope of the disclosure.

Embodiments include techniques for differentiating a probe signal transmission from another AIOT operation, e.g., paging for inventory, command, etc. Said differentiation is beneficial to avoid power consumption in devices without DO-A traffic. For example, devices without DO-A traffic may benefit from limiting the power consumption associated with decoding the probe signal.

In an embodiment, a probe signal may consist of an AIOT preamble-only transmission. For example, a reader may transmit a preamble for synchronization without an associated message. Alternatively, a reader may transmit one of a defined set of preambles for AIOT immediately followed by one of a defined set of postambles. In another example, a reader may transmit a specific preamble or preamble sequence which is reserved for, configured for, or preconfigured for a probe signal. For example, all AIOT transmissions other than probe signal may be initiated by a first preamble or set of preambles, while a probe signal may be performed by sending a second preamble or set of preambles, where the second preamble or set of preambles is different than the first preamble or set of preambles.

In an embodiment, a probe signal may include a paging message or similar message that initiates a random access procedure. In some embodiments, this initiation this paging or similar message initiating a random access procedure may be similar to an inventory procedure. In one example, the paging message may have a specific format, field, or property to differentiate the message from a paging message for DT or DO-DTT messages. Such differentiation can be easily detectable by a simple AIOT device.

For example, a probe signal may have a special or reserved value for an expected field of the message. Examples of a special or reserved value for the expected field may include: a special value for device ID, e.g., all ‘1’, a special value for resource configuration information, a value of 0 for a number of resources or number of occasions, a specified value for a field, e.g., random access type, which is used for purposes such as for the paging message to indicate either a contention-free or contention-based access.

In an example, a probe signal may have a different length compared to a normal paging message. In an example, a device may determine the length of the paging message based on the number of bits between the preamble and postamble transmissions. The device may determine the presence of a probe signal based on the length of the transmission. For example, the device may determine a length different than a specified length, a length within or not within a specified range, etc. Additionally or alternatively, in an example, the paging message may contain a field for the length of the message. A device may determine the presence of a probe signal based on the indicated length being of a specific value, within or not within a specified range of values, etc.

In an example, a probe signal may have a specific value for a paging message type. For example, a paging message may be defined with a type field, where a specific type value is used for normal paging, and another type value is used for a DO-A paging message.

In another example, a probe signal may be an occasion sync message or similar message that normally delimits the access occasions within an inventory procedure or random access procedure. For example, the same message format may be used for occasion sync during random access and for transmission of the probe signal. In such cases, the same or similar mechanisms that apply for a DO-A paging message may apply for the probe signal. For example, the occasion sync message transmitted as the probe signal may have a reserved or special value for a specific field, e.g., sync counter, resource configuration, etc., that is normally transmitted in an occasion sync message to distinguish the message as a probe signal.

In another example, a probe signal may have the same format as another message or transmission by the reader, such as a WTRU, but may be transmitted on a specified, configured, or preconfigured frequency. For example, a specific frequency, e.g., a set of resource blocks, a carrier frequency, etc., may be associated, configured, or preconfigured for probe transmission. For example, a reader may transmit a paging message on a configured or preconfigured frequency, which may then be identifiable a probe signal based on being transmitted on said frequency.

In embodiments disclosed herein, a reader may transmit a probe signal which addresses or indicates only a subset of devices having DO-A data to respond. Elements of different embodiments covering the transmission of a probe signal which addresses or indicates only a subset of devices having DO-A data to respond may be combined with each other and different elements of different embodiments covering the transmission of a probe signal which addresses or indicates only a subset of devices having DO-A data to respond may be combined with other compatible embodiments described herein without departing from the scope of the disclosure.

In an example, a subset of devices may be identified based on any one or combination of: a QoS or latency of the DO-A data pending for transmission, a number of probe signals received, a type of device, a device address or grouping, and a DO-A data size or amount of data to be transmitted.

For example, and potentially in combination with any of the other examples disclosed herein, the probe signal may indicate the specific latency or QoS associated with the data. In an example, the probe signal may indicate that a device which has data with a latency requirement less than X seconds should respond to the probe signal. For example, a finite set of latency levels, e.g., low, medium, and high, may be defined based on a configured or preconfigured value of actual latency. The probe signal may indicate that a device which has a latency requirement of one of low, medium, or high should respond to the probe signal.

For example, and potentially in combination with any of the other examples disclosed herein, the probe signal may indicate a number of probe signals to be received by a device before the device is to respond. Additionally or alternatively, the probe signal may indicate whether the probe signal is the first in a set of repeated/retried probe signals, or its number within the set.

For example, and potentially in combination with any of the other examples disclosed herein, the probe signal may indicate which type of device should respond. For example, the device type may refer to any of the capabilities of the device, a configured or preconfigured device type, a type of service or application, etc.

For example, and potentially in combination with any of the other examples disclosed herein, the probe signal may reference one or a group of devices based on a configured or preconfigured address, ID, index, or group number.

For example, and potentially in combination with any of the other examples disclosed herein, the probe signal may indicate a data size, e.g. a maximum data size, a minimum data size, or a range of a data size, for which the device should respond to the probe signal. For example, a probe signal can indicate that devices with data up to a maximum size should respond.

In some embodiments, a reader, such as a WTRU, may indicate the information/indications described herein (e.g., latency, number of probe signal, device type, etc.) explicitly or implicitly in or by the probe signal. For example, if the probe signal is sent with a paging message, a field within the paging message may indicate an index referencing the specific property option. Alternatively, the probe signal may indicate a different property value by using a different preamble value, a different preamble length, a different transmit power, a different resource element, e.g., time, frequency, space, code, etc., a different signature, etc.

In embodiments disclosed herein, a reader may signal the end of a DO-A operation, that was initiated by a probe signal, using an explicit transmission from the reader to the device. Elements of different embodiments covering the termination of a DO-A operation may be combined with each other and different elements of different embodiments covering the termination of a DO-A operation may be combined with other compatible embodiments described herein without departing from the scope of the disclosure. Explicitly signaling the end of a DO-A operation may allow devices without DO-A data pending for transmission to ignore decoding and/or responding to any subsequent transmissions by the reader. In an example, the reader may transmit the DO-A operation termination signal like the probe transmission. For example, a reader may use a first dedicated preamble-only transmission for the probe signal and may use a second dedicated preamble-only transmission as the termination signal. In another example, the termination signal may be a paging-like message with a message type field which is different than the probe signal.

In an embodiment, a device, such as an AIOT device, may determine whether and/or when to respond to a probe signal. In an example, a device may be configured with a maximum amount of time to respond to a probe signal. For example, upon reception of a probe signal, a device may respond if it is capable of responding, e.g., the device has sufficient energy to respond, within a configured or preconfigured time of receiving the probe signal, of the beginning/end of the probe signal, etc.

A device may respond to a probe signal if it has data available for transmission to the reader. In addition, a device may respond to a probe signal if it meets the criteria indicated by the probe signal, where the criteria herein may be examples of such criteria. For example, if the required latency of the data meets the latency criteria indicated in the probe signal, the device may respond.

In an embodiment a device, such as an AIOT device, may determine the properties of the probe signal response. For example, the device may respond to the probe signal in any of the forms describe herein including, for example, a preamble-only transmission, a preamble followed by a message, such as an L2 message, etc.

In an example, a probe signal response may be a message having the same or a similar format as a random access initiation, i.e., a MSG1 transmission. In some examples, the probe signal response may contain a special field, a special random ID, an additional random ID, a different length ID, an ID chosen from a set of reserved IDs associated with probe signal response, etc. A device may transmit a probe signal response that includes, for example, a special preamble followed by a message which contains a random ID, a configured or preconfigured ID, or an assigned ID.

In an example, a probe signal response may have a predefined, configured, or preconfigured property to identify it as a probe signal response. Additionally or alternatively, the probe signal response may explicitly indicate, or may further have a property which indicates any one or combination of the following: a size of the DO-A data to be transmitted by the device, a QoS or latency of the DO-A data pending for transmission, a type of device, and a device address, ID, index, or grouping.

For example, and potentially in combination with any of the described indications herein, the probe signal response may indicate the size of the data to be transmitted, whether the size is in a preconfigured range, etc.

For example, and potentially in combination with any of the described indications herein, the probe signal response may indicate the specific latency or QoS associated with the data. For example, the probe signal response may indicate that the device has data with a latency requirement less than X seconds. In another example, a finite set of latency levels, e.g., low, medium, and high, may be defined based on a configured or preconfigured value of actual latency. In an example, the probe signal response may indicate that the device has a latency requirement of one of low, medium, or high.

For example, and potentially in combination with any of the described indications herein, the probe signal response may indicate which type of device is responding. In some examples, the device type may refer to any one or more of the capabilities of the device, a configured or preconfigured device type, a type of service or application, etc.

For example, and potentially in combination with any of the described indications herein, the probe signal response may indicate one or a group of devices. The indication may be based on a configured or preconfigured address or group number.

In some embodiments, to avoid unnecessary power consumption at devices which are not performing DO-A transmission, a device without DO-A data may ignore paging messages, inventory initiation messages, command messages, etc. which follow the probe signal transmission. Specifically, a device may abstain from decoding and/or responding to any R2D message for a (pre)configured period of time following transmission of the probe signal. In some examples, the device may abstain from decoding and/or responding to any R2D message until it receives a termination signal from the reader. In some examples, the device may abstain from decoding and/or responding to any R2D message until the device receives a configured or preconfigured number of sync message transmissions following a probe signal.

In some embodiments, a device, such as an AIOT device, may transmit data as the probe signal response or may transmit data along with a probe signal response. For example, if the probe signal indicates and/or identifies a single device, the single device may transmit data following reception of the probe signal. For example, the probe signal may indicate a preamble associated with the single device. In another example, a device may receive a specific probe signal indication information in a procedure prior to initiation of DO-A, e.g., in an inventory procedure, a write command, etc. Specific probe signal indication information may include, for example, e.g., to which one or more preambles to respond. The device may store such information to identify future probe signal properties, for example information indicating an index in a message, a preamble sequence, etc., and may determine the need to transmit data following the probe signal reception matching one or more pieces of the stored information.

In another example, a device may be configured, e.g. in a previous procedure, with additional information to use for transmission of the response and/or data following reception of the probe signal. For example, the additional information may include a frequency resource, a time resource or access occasion, an amount of time to wait following the probe signal to transmit the response/data, a preamble signal sequence, etc. For example, if configured with a preamble sequence corresponding to data transmission on frequency f1, if the device receives that configured preamble sequence in a probe signal or similar message, it may respond with a probe signal response and/or data transmitted on f1. For example, if configured with a preamble sequence corresponding to data transmission after a time T, if the device receives that configured preamble sequence, it may respond at a time T after the reception of the probe signal with a probe signal response and/or data. In another example, the device may respond a number of access occasions T after reception of the probe signal, where the access occasions may be delimited by one or more other R2D transmissions.

In another example, a device may determine whether to transmit data or to transmit a probe signal response only based on the received probe signal properties. For example, upon reception of a first preamble sequence, or a probe signal having a first probe signal characteristic as described herein, a device may transmit a probe signal response only. In this example, the device may transmit DO-A data as part of a subsequent procedure after transmission of the probe signal response. For example, the device may transmit the DO-A data as part of a random access procedure triggered by a paging message. Further, for example, upon reception of a second preamble sequence, or a probe signal having a second probe signal characteristic as described herein, a device may transmit DO-A data or DO-A data along with the probe signal response without waiting for a subsequent procedure.

In another example, a device may determine whether to transmit data or to transmit a probe signal response only based on the amount of data pending for transmission. For example, a device may be configured or preconfigured with a threshold and may transmit data if the size/amount of DO-A traffic to transmit is below a threshold or may transmit a probe signal response only if the size/amount of data to transmit is above the threshold. A device may further determine such threshold based on information provided in the probe signal transmission. Examples of the information in the probe signal include a different identity in the message, a different preamble, etc. In an example, the probe signal may indicate the presence of a resource for transmission of DO-A data by the device immediately following the probe signal. If the amount of data to transmit is larger than the resource, the device may transmit a probe signal response to indicate to the reader that transmission of the DO-A data should be performed in a subsequent procedure, e.g., following a paging message.

In some embodiments, a reader, such as a WTRU, may trigger a procedure based on determining the presence of a probe signal response or determining a number of probe signal responses. For example, a reader may monitor for transmission of a probe signal response following its probe signal transmission. In some examples, a reader may monitor for a probe signal response for a finite period of time, e.g., a configured amount, an amount defined by specification, an amount which is associated with the device types being probed, an amount which is associated with the information in the probe signal transmission, etc.

In an example, a reader may perform a subsequent procedure upon detection of at least one response, based on the number of responses, based on the type of response, etc., during the monitoring period. For example, a reader, such as a WTRU, may initiate a random access procedure by transmitting a paging message if at least one response is received during the monitoring period. Such random access procedure may be specifically used to address the DO-A devices. If no response is received during the monitoring period, the reader may not initiate a subsequent procedure for DO-A transmission. Additionally or alternatively, a reader may, for example, repeat the probe signal multiple times and may detect the cumulative number of responses from each repetition before performing a subsequent procedure or determining the type of subsequent procedure to perform based on the cumulative number of responses.

For example, a reader may determine the type of procedure based on any combination of one or more of the following: a number of responses received, a signal strength or energy of one or more responses received, whether the reader is able to decode the response and/or determine the number of distinct responses received or not, whether the reader is able to decode the specific signals sent in each of the responses, whether the responses, e.g. the preamble sequences, are unique, and how many unique responses are received.

In some examples, and potentially in combination with any of the other factors described herein, the reader may determine the type of procedure based on any one or more of: whether one response or more than one response is received, whether the number of responses received is less than a threshold or not, whether the number of responses received falls within a specific range, whether one response per frequency resource or multiple responses in any frequency resource is received, on the number of responses received per frequency resource and whether, for any/all particular frequency resource(s) it is larger or smaller than a threshold.

In some examples, and potentially in combination with any of the other factors described herein, the reader may determine the type of procedure based on whether the received power or the received or measured SINR of the one or more responses is above a threshold or not.

In some examples, and potentially in combination with any of the other factors described herein, the reader may determine the type of procedure based on whether the reader is able to decode the number of responses, or not. In some examples, a reader may be able to detect at least one response but may not be able to detect the exact number of distinct devices which responded due to the interference caused by each response.

In some examples, and potentially in combination with any of the other factors described herein, the reader may determine the type of procedure based on whether the reader is able to detect each of the preamble sequences sent by a set of devices.

In some examples, and potentially in combination with any of the other factors described herein, the reader may determine the type of procedure based on whether all of the preamble sequences received from the different devices are unique or not and/or a number of received unique preamble sequences.

Examples of determining among different types of the procedure to perform include any combination of one or more of the following: determining between a contention-free random access procedure or a contention-based random access procedure, determining whether to perform a random access procedure exclusively for DO-A transmissions or for both DO-A transmissions and inventory procedures, determining whether the procedure includes transmitting a paging message or whether the procedure includes transmitting one or more occasion sync messages without a paging message, and determining whether the procedure includes a random access procedure or a command procedure, e.g., a transmission of an R2D message, such as a paging message, followed by transmission of the DO-A data by a device.

In some embodiments, a reader, such as WTRU, may trigger a random access procedure for DO-A devices. In an example, a reader may trigger a random access procedure upon reception of a response from at least one device during the monitoring period following transmission of a probe signal. The reader UE may initiate a random access procedure by transmitting a paging message. The paging message may contain information indicating that the triggered paging is dedicated to the devices that responded to the probe signal.

In some examples, the paging message may be preceded by a special preamble signal dedicated for indicating that the subsequent random access is for DO-A devices. Additionally or alternatively, the paging message may have a special or reserved value for an expected field of the message. Examples of a special or reserved value for an expected field may include any combination of one or more of the following: a special value for a device ID, such as all ‘1’, a special value for resource configuration information, a value of 0 for a number of resources or number of occasions, a specified value for a field, e.g., random access type, which is used to, for example, indicate if the paging message indicates a contention-free versus contention-based access. Additionally or alternatively the paging message for DO-A devices may have a different length compared to a normal paging message. Additionally or alternatively, the paging message may use a special value for paging message type.

In an embodiment, for non-DO-A devices to ignore such DO-A paging message, the non-DO-A devices may ignore any received messages for a period of time, for a number of reader transmissions, or until a termination signal as described.

In an example, the random access procedure triggered by the reader may be contention-free or contention-based. For example, if the procedure is contention-based, the reader may transmit a paging message to trigger transmission of MSG1 containing a random ID by multiple DO-A devices, and may follow the procedure, including, for example, transmission of MSG1, contention resolution in MSG2, etc., consistent with contention-based random access. In another example, if the procedure is contention-free, the reader may transmit a paging message which triggers direct data transmission by the one or more DO-A devices without needing to transmit MSG1 and MSG2 for contention resolution.

A reader may determine whether to trigger a contention-free random access procedure or a contention-based random access procedure based on the number of devices that have responded and/or which the reader is able to detect as having responded. For example, if a single device, possibly per frequency, has responded, the reader may trigger a contention-free random access procedure, otherwise, the reader may trigger a contention-based random access procedure

In another example, if the number of devices having responded is known and/or if the reader is able to distinguish a different property associated with each device response, the reader may trigger a contention-free random access procedure, otherwise, the reader may trigger a contention-based random access procedure. Examples of a different property associated with each device response may include: all the devices use a different preamble sequence, all the devices have transmitted a different message content, all the devices have used a different random ID, etc.

In an embodiment, upon reception of at least one probe response signal, a reader, such as a WTRU, may trigger transmission of one or more DO-A devices using a R2D message, such as a sync message. For example, a reader may transmit an R2D message to trigger DO-A data transmission following the R2D message. The reader may perform such operation in case there is a single DO-A device that was detected during the monitoring for the probe signal response. In this case, the R2D message may contain, for example, only resource information, e.g., the allowed transmission duration, the frequency to transmit on, etc. Additionally or alternatively, in the case where multiple responses were detected, but not limited to only in the case of multiple responses, the reader may identify a device to respond to the R2D message by including some elements of the probe signal response in the R2D message.

In an example, if the probe response uses a specific or special sequence, the R2D message may use the same sequence. For example, if the probe response uses a specific or special sequence, the R2D message may include, in a L2 message, the sequence, or an indicator that is associated, e.g., by specification or preconfiguration, to that sequence. In another example, if the probe response includes a random ID, the R2D message may include the same random ID. From the device side, the device may perform transmission of the DO-A data upon reception of an R2D message containing the information element which was included in the D2R message.

In an embodiment, a reader, such as a WTRU, may assume a random access procedure is triggered that has a predefined or pre-signaled configuration. For example, following reception of at least one probe response signal, the reader may transmit R2D sync messages to create access occasions for a random access procedure whereby the random access procedure may follow a predefined configuration or a configuration that was signaled in the probe signal.

In an example, DO-A devices may be preconfigured, for example during an inventory procedure, with a specific order of a R2D message following the probe signal response to which it should respond. For example, a device may be configured with a DO-A index of X. Following transmission of the probe signal response, the DO-A device may transmit data following the Xth R2D signal following the probe signal response. The reader may perform a number of R2D signal transmissions up to the maximum value of X that can be configured in any DO-A device.

In another example, the probe signal may itself configure the subsequent random access for the DO-A devices. For example, the probe signal may define the number of access occasions for a potential random access procedure which may be triggered if at least one DO-A device responds to the probe signal. In such case, the R2D sync messages may carry an indication of access occasions which are being triggered for a DO-A random access procedure.

In an embodiment, a reader, such as a WTRU, may determine when to trigger a procedure based on information from the probe response signal. For example, reader may use information from the probe response signal to determine when to trigger the DO-A procedure. For example, the devices may send information about the QoS or latency associated with the data pending for transmission. The reader may determine a time to trigger the DO-A procedure based on this information. For example, the reader may trigger the DO-A procedure prior to the time requirements of the most critical probe response signal. For example, the reader may trigger the DO-A procedure a configured time period prior to that time requirement. For example, if the reader is configured with periodic resources, for example periodic resources that are similar to a configured grant, the reader may trigger the DO-A procedure in one of the periodic resources which fall in the time requirement period of the tightest requirement device.

In another example, the reader may trigger multiple procedures associated with different time requirements or associated with a range of time requirements. For example, the reader may group all responses with a time requirement less than a first threshold into a single procedure, and the remaining responses into a separate procedure. The reader may indicate the corresponding time requirement in the R2D message initiating the procedure.

As will be described in more detail in the following example embodiments, a reader may request, from the network, resources for a subsequent procedure.

In an example, to avoid allocation of resources for a DO-A procedure with each probe signal, a reader may request resources from the network for the subsequent procedure when it receives at least one probe response signal from a device following probe signal transmission. A reader may send such a request in an SR, a MAC CE such as a BSR, or an RRC message.

For example, a WTRU may be configured with an SR that may or may not be associated with each probe signal transmission resource. If the probe signal transmission results in at least one response, the WTRU may trigger SR to receive resources to be used for the subsequent procedure, for example a random access procedure. Additionally or alternatively, the SR may trigger the network to activate resources, which were previously configured, for example through RRC signaling. For example, following the SR transmission, the network may send an activation signal, for example DCI or a MAC CE, to activate a set of resources configured for the DO-A data transmission procedure. The activation signal may further indicate the specific configuration from a set of multiple configurations to be used by the reader for the procedure.

In another example, a reader, such as a WTRU, may transmit a message, such as a MAC CE or an RRC message, with information from one or more of the received probe signal responses. For example, a reader may transmit any combination of one or more of: an indication of whether the reader detected one or multiple responses, an indication of whether the reader is able to determine the number of devices that responded and/or the number of responding devices, information about the required DO-A data message size, information about the identity of the devices, and information about the QoS/timing requirements. For example, the reader may receive one or more data size indications from the probe signal responses. For example, the reader may provide, to the network, the maximum size, each of the received data sizes, etc. Additionally or alternatively, for example, if the reader receives an ID, e.g., a random ID, a preamble sequence, etc., the reader may provide this to the network. Additionally or alternatively, for example, the reader may provide, to the network, the minimum time requirement, the maximum time requirement, all of the time requirements, etc.

In an embodiment, a reader, such as a WTRU, may transmit a message to the network during the random access procedure to request resources for each occasion of the random access procedure. In such case, the UE may use the information of the preamble signals received in response to the probe signal, along with the data transmission size of the DO-A transmission by the device which won the contention in the previous occasion. For example, for the first occasion, the reader may request the maximum size of any device transmission based on the maximum size associated with or indicated by any received preamble. If during a specific occasion, the reader receives a transmission, for example a MSG3 transmission, corresponding to the maximum size and there are no known other devices which may transmit based on this maximum size, for example where only a single preamble was received with this maximum size, the next allocation of resources for the next access occasion requested by reader from the network may be of a smaller size. For example, the reader may request the size corresponding to the preamble indicating the next maximum size after having removed the maximum size due to that size being transmitted in the previous occasion and thus no longer applicable.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit receive unit (WTRU), the method comprising:
transmitting a first preamble sequence of a set of preamble sequences;
receiving at least one second preamble sequence of the set of preamble sequences;
determining that a single second preamble sequence is received from a first device; and
transmitting a first message to the first device indicating that the first device is to perform a contention-free random access procedure.

2. The method of claim 1, wherein the single second preamble sequence is received in a period of time following the transmitting the first preamble sequence, the method further comprising:
requesting from a network a resource allocation based on a size associated with the single second preamble sequence.

3. The method of claim 2, wherein the requesting includes sending an indication of the size of the requested resource allocation.

4. The method of claim 2, further comprising:
receiving, from the network, an indication of the resource allocation;
transmitting the first message, to the first device, in a first portion of the resource allocation; and
receiving a contention-free data transmission from the first device in a second portion of the resource allocation.

5. The method of claim 4, wherein:
the first message indicates that the first device is to transmit data contention-free and indicates at least the second portion of the resource allocation.

6. The method of claim 1, wherein a value of the single second preamble sequence is based on a size of a subsequent data transmission.

7. A method performed by a wireless transmit receive unit (WTRU), the method comprising:
transmitting a first preamble sequence of a set of preamble sequences;
receiving at least one second preamble sequence of the set of preamble sequences;
determining that multiple second preamble sequences are received; and
transmitting a second message to a second device of a plurality of devices associated with the multiple second preamble sequences indicating that the second device is to perform a contention-based random access procedure.

8. The method of claim 7, wherein the multiple second preamble sequences are received in a period of time following the transmitting the first preamble sequence, the method further comprising requesting from a network a resource allocation including one or more contention-based resources, wherein a size of the resource allocation is based on a maximum of one or more sizes associated with the multiple second preamble sequences.

9. The method of claim 8, further comprising:
receiving, from the network, the resource allocation that includes the one or more contention-based resources;
transmitting, to the second device, the second message in one or more first resources of the resource allocation;
receiving, in at least one contention-based resource of the one or more contention-based resources from the second device, an MSG1 transmission containing a random number;
transmitting, in one or more second resources of the resource allocation to the second device, a MSG2 transmission containing the random number; and
receiving, in one or more third resources of the resource allocation from the second device, a data transmission.

10. The method of claim 7, wherein a value of each second preamble sequence of the multiple second preamble sequences is based on a size of a respective subsequent data transmission.

11. The method of claim 7, wherein the second device is an ambient Internet Of Things (AIOT) device.

12. A wireless transmit receive unit (WTRU) comprising circuitry, including a transmitter, a receiver, a processor, and a memory, configured to:
transmit a first preamble sequence of a set of preamble sequences;
receive at least one second preamble sequence of the set of preamble sequences;
determine whether a single second preamble sequence or multiple second preamble sequences are received;
on a condition that the single second preamble sequence is received from a first device, transmit a first message to the first device indicating that the first device is to perform a contention-free random access procedure; and
on a condition that the multiple second preamble sequences are received, transmit a second message to a second device of a plurality of devices associated with the multiple second preamble sequences indicating that the second device is to perform a contention-based random access procedure.

13. The WTRU of claim 12, wherein the circuitry is configured to, on the condition that the single second preamble sequence is received in a period of time following the transmission of the first preamble sequence, request from a network a resource allocation based on a size associated with the single second preamble sequence.

14. The WTRU of claim 13, wherein the circuitry is configured to send, to the network, an indication of the size of the requested resource allocation.

15. The WTRU of claim 13, wherein the circuitry is configured to:
receive, from the network, an indication of the resource allocation;
transmit the first message, to the first device, in a first portion of the resource allocation; and
receive a contention-free data transmission from the first device in a second portion of the resource allocation.

16. The WTRU of claim 15, wherein:
the first message indicates that the first device is to transmit data contention-free and indicates at least the second portion of the resource allocation.

17. The WTRU of claim 12, wherein the circuitry is configured to, on the condition that the multiple second preamble sequences are received in a period of time following the transmission of the first preamble sequence, request from a network a resource allocation including one or more contention-based resources, wherein a size of the resource allocation is based on a maximum of one or more sizes associated with the multiple second preamble sequences.

18. The WTRU of claim 17, wherein the circuitry is configured to:
receive, from the network, the resource allocation that includes the one or more contention-based resources;
transmit, to the second device, the second message in one or more first resources of the resource allocation;
receive, in at least one contention-based resource of the one or more contention-based resources from the second device, an MSG1 transmission containing a random number;
transmit, in one or more second resources of the resource allocation to the second device, a MSG2 transmission containing the random number; and
receive, in one or more third resources of the resource allocation from the second device, a data transmission.

19. The WTRU of claim 12, wherein a value of the single second preamble sequence and a value of each second preamble sequence of the multiple second preamble sequences is based on a size of a respective subsequent data transmission.

20. The WTRU of claim 12, wherein the circuitry is configured with at least the first preamble sequence for transmission; and
with at least the single second preamble sequence and the multiple second preamble sequences for reception.
